(19) United States
(12) Patent Application Publication
(10) Pub. No.: US 2008/0195446 A1
(43) Pub. Date: Aug. 14, 2008

(54) Cross-program dependency scheduling

(76) Inventor: Steven B. Bowler, Hudson, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/694,502

(22) Filed: Oct. 24, 2003

Related U.S. Application Data
(60) Provisional application No. 60/421,025, filed on Oct. 24, 2002.

(51) Int. Cl. G06Q 10/00

(52) U.S. Cl. 705/8

(57) ABSTRACT

A scheduling application that provides decision support for program managers by interrelating activities across multiple product-development programs and by creating dependencies for such activities. The application is platform independent and uses Internet technologies to manage multiple dependent programs. The application manages dependent programs by graphically displaying an activity schedule, displaying real time status of activities, and displaying available resources. Changes to an activity in one dependent program will reschedule activities in other programs. Alternatively, a change to an activity in one dependent program sends an electronic notification to parties of programs affected by the change for ratification of the change.

### CROSS REFERENCE TO RELATED APPLICATIONS

Applicant claims priority of U.S. Provisional Patent Application in the name of Steven B. Bowler, application No. 60/421,025, filed on Oct. 24, 2002.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates to new product development, and particularly to Internet software that enables collaborative program management during new product development.

2. Description of Prior Art

Program Management includes scheduling of activities and their interdependencies, raising and resolving issues, managing the creation and release of critical intellectual property, building prototypes, and releasing products to full production. The overall product life cycle is managed in this manner from conception to conclusion. Program management resources include metrics, problem logs, alerts, team meetings, phase exit reviews, and audits. These resources are used to keep a large-scale program on track, to put the program on hold, or to kill the program altogether to minimize loss.

History of Collaborative Scheduling Programs.

In the past, scheduling of a program or project involved the creation of a timing chart, called a Gantt diagram, where a hierarchy of activities is displayed graphically along an axis of time. The Gantt diagram assisted program managers and team members to visualize the interdependencies of their activities. The diagram displayed task names, resources required for such tasks, and dates for starting and ending various activities.

As technologies evolved, computer applications for scheduling emerged such as FastTrack™ Schedule for Macintosh™ and Microsoft™ Project™ for the personal computer. These applications produced the required graphical output of the Gantt diagrams, but they suffered from a poor ability to communicate the schedule data to program managers and team members. Schedule data was accessible from only one computer, and the only output option was a printer.

Accessibility of schedule data improved with client-server architectures and applications. Companies such as Artemis and Primavera developed applications that enabled sharing of schedules among licensed users in the same IT (Information Technology) infrastructure. Using applications to share schedules outside company boundaries and IT infrastructures usually resulted in miscommunication or even no communication.

A new breed of applications using operating system-independent power of the Internet began to emerge. These applications used enterprise-class relational databases that could link program data in newer relational ways. At the same time, professional service organizations were advocating the use of technology bookshelf processes to separate the development of pure technology from the delivery of new product designs to speed new products to market. A new technology, once tested and approved, could then feed multiple platform products. This meant that multiple programs could be dependent on the completion of the same predecessor technology development. Traditional Project Management only handled dependencies inside the project plan. Thus, critical developments outside the program could adversely affect profitability without warning.

What is needed, therefore, is a scheduling system capable of creating, displaying, and managing cross-program dependencies. What is further needed is such a scheduling system that communicates with a database and has a graphical user interface to display how schedule and status of an activity in one program can impact the schedule and status of an activity in another program. What is also need is such a scheduling system that simultaneously implements fixed-duration scheduling with electronic notification.

### BRIEF SUMMARY OF THE INVENTION

This invention pertains to software for the mechanics of scheduling. This involves scheduling algorithms that cross traditional program boundaries, providing a new perspective on scheduling, which is especially useful for enterprises managing multiple dependent programs.

The present invention exists as a stand-alone application and can also be a component of a broader set of software modules that comprise an overall program management suite. The present invention is directed to a scheduling system that establishes cross-program dependencies for phase, task, deliverable, and gate activities. The scheduling system includes Internet software that displays Gantt charts, organizes online meetings, sends e-mail alerts, and provides document storage and retrieval. Dependencies and status of activities are displayed in real-time for access by all program managers.

Modification of an activity by one manager causes the system to notify all managers affected by the modification. Alternatively, the system uses permission constraints to prevent one program manager from modifying or negatively impacting another's program without a closed-loop notification and approval. Before a schedule can change in one program that adversely affects the schedule of another program due to fixed schedule durations and finish-to-start dependencies, a notification is sent to the affected program manager. Program managers in multiple programs can be immediately alerted to and respond appropriately to slippage in dependent programs outside of their control. If a program manager accepts the schedule slip, then the program is automatically rescheduled. If the program manager rejects the schedule slip, then the conflict is identified in a message back to the originating program manager, and the two must resolve the schedule conflict. Each program activity will carry a section that shows these cross-program dependencies and flags for schedule conflicts. The alerts will roll up to the highest-level owner where the schedule conflict has an impact.

Objects

It is an object of the present invention to create a schedule system that enables collaborative program management during product development.

It is another object of the present invention to create such a scheduling system that communicates dependencies in any program in the same database.

Another object of the present invention is to create such a scheduling system that prevents one program manager from negatively impacting another's program without a closed-loop notification.

Features

A feature of the present invention is a rescheduling algorithm that allows permission constraints.

Another feature of the present invention is a graphical display of program status information and ownership information of dependent or related programs.

Advantages

There are many advantages to the invention, including the following. Other advantages will be apparent to those skilled in the art.

An advantage of the present invention is real time interaction between dependent schedules that were previously managed separately.

Another advantage is that program managers and senior executives can make informed decisions and execute their decisions instantaneously. All parties affected by schedule conflicts receive instant notification.

Additional advantages include optimized allocation of resources, simple establishment of dependencies, single IT platform, and automated schedule conflict resolution.

### BRIEF DESCRIPTION OF THE DRAWINGS

FIG. 1 is a flow chart of the history of the development of collaborative scheduling programs.

FIG. 2 is a flow chart of the decision-making process involving cross program dependencies to alert manager of slips in one program that impact another program.

FIG. 3 Is a status display of the scheduling system showing an outside task not impacting on the critical path of the focus program.

FIG. 4 Is a status display of the scheduling system showing an outside task impacting the critical path of the focus program.

FIG. 5 Is a status display of the scheduling system showing tasks from the focus program automatically rescheduled from the slip of an outside task.

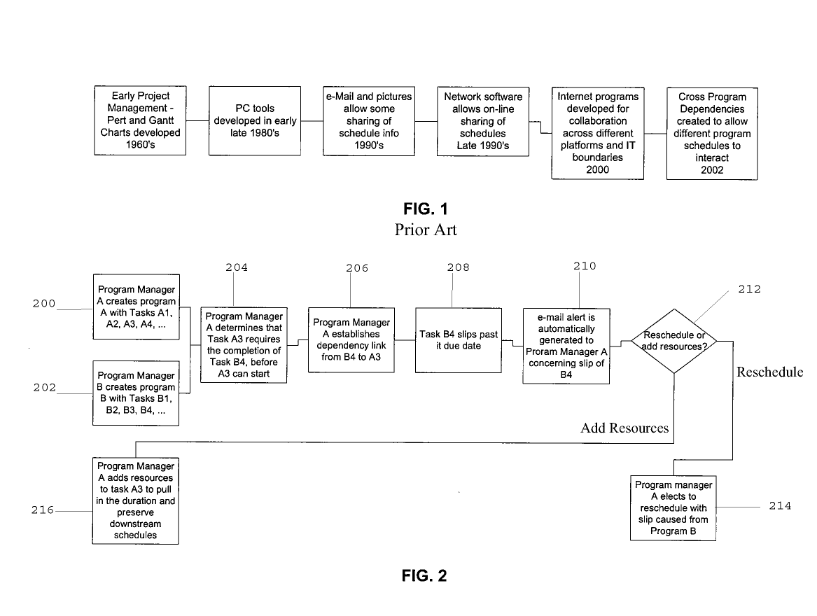

### DETAILED DESCRIPTION OF THE INVENTION, INCLUDING THE PREFERRED EMBODIMENT

In the following detailed description of the invention, reference is made to the accompanying drawings, which form a part hereof, and in which are shown, by way of illustration, specific embodiments in which the invention may be practiced. It is to be understood that other embodiments may be utilized, and structural changes may be made without departing from the scope of the present invention.

The invention is implemented in a software application written in any number of programing languages such as Java, VisualBasic, or C++. The invention is preferably written in Java because Java ports well from one operating system to another, which means that Java applications can run on any computer that has implemented the Java virtual machine. The preferred platform is one capable of running a web server (such as Apache, Microsoft IIS, or Weblogic) and a database server, such as Microsoft Windows2000 operating system running in a personal computer. Other possible platforms include Unix-based platforms such as those sold by Sun Microsystems, Linux-based systems, or MacOS-based systems.

In FIG. 2, Program manager A and Program manager B create separate programs with several tasks. Program manager A determines task A3 cannot begin until completion of task B4. Program manager A establishes a cross-program dependency between task A3 and task B4. As task B4 slips past its due date, Program manager A automatically receives an e-mail alert, and Program manager A can choose to reschedule or add resources. Program manager A elects to reschedule task A3.

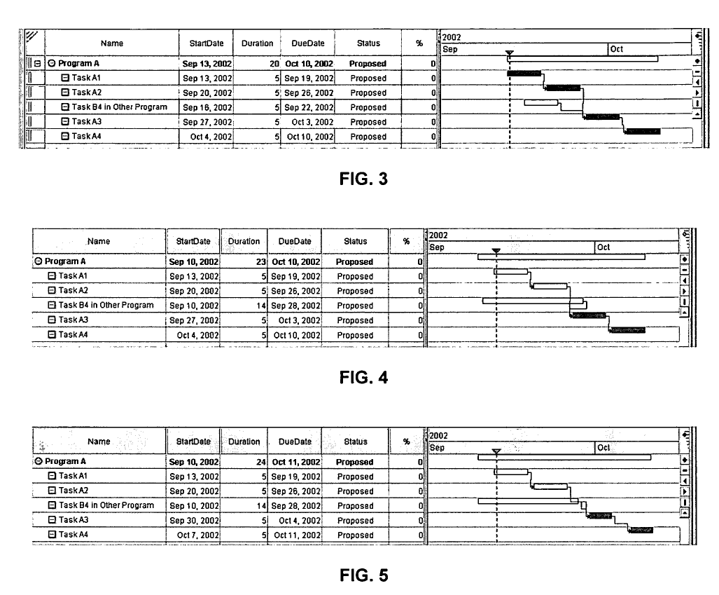

Referring now to FIG. 3 through FIG. 5, the scheduling system is shown according to the preferred embodiment. The scheduling system is shown in Gantt chart format to show a sequence of events. In FIG. 3, the dependent task B4 from program B is shown on the Gantt chart for Program A. Task B4 is not impacting on the Critical Path of Program A, so no action is required. In FIG. 4, a slip in schedule for Task B4 in Program B is now impacting on Task A3 in Program A. In the FIG. 5, the Program manager for Program A has rescheduled Program A to recognize the slip caused in Program B.

1. A computerized method of managing programs, said method comprising:
receiving interdependencies between activities from a plurality of programs; and
graphically displaying said interdependencies of said activities in a computerized schedule available to multiple program managers such that modification of one of said interdependent activities updates said schedule of said activities.

2. A computerized method of managing programs, said method comprising:
storing information about activities from a plurality of programs in a database, the information including interdependency data specifying interdependencies between the activities; and
graphically displaying said interdependency data in a program schedule wherein a modification of one of said activities in one of said programs causes an effect of said modification to said program schedule to be displayed.

3. A computerized method of managing programs, said method comprising: receiving interdependencies between activities from a plurality of programs; and
graphically displaying said interdependencies of said activities in an electronic schedule, viewable by multiple program managers, such that a modification of one of said activities reestablishes said interdependencies in an updated, graphical display of said electronic schedule.

4. The method of claim 3 wherein said modification of one of said activities initiates an approval request requiring a response before said modification.

5. The method of claim 3 wherein said modification also transmits an electronic message to managers of programs affected by said modification.

6. (canceled)

7. The method of claim 3 wherein said electronic schedule is operable for managers to raise issues, alert managers of scheduling changes, arrange team meetings, and initiate phase exit reviews.

8. The method of claim 3 further comprising displaying problem logs.

9. The method of claim 3 wherein said activities comprise phases, tasks, deliverables, and gates.

10. A computerized method of managing programs, said method comprising:
receiving interdependencies between activities from a plurality of programs; and
graphically displaying an impact of a schedule and a status of one of said activities in one of said programs on said schedule and said status of one of said activities in another of said programs.

11. A system for managing a program, said system comprising:
a database operable to maintain activities identified from a plurality of programs; and
a processor programmed to:
receive interdependencies between said activities; and
graphically display said interdependencies of said activities in an electronic schedule, viewable and modifiable by multiple program managers across a network, such that modification of a scheduled activity reestablishes said interdependencies in an updated, graphical display of said electronic schedule.

12. The system of claim 11 wherein modification of an activity initiates an approval request, said approval request requiring a response before said electronic schedule is updated with reestablished interdependencies.

13. The system of claim 11 wherein an attempted modification transmits an electronic message to managers of programs affected by said attempted modification.

14. The system of claim 11, wherein said processor is further programmed to provide fixed-duration scheduling with electronic notification.

15. The system of claim 11, wherein said system is operable for displaying problem logs.

16. The system of claim 11 wherein said system is a web-based Program Management Application.

17. The system of claim 11 wherein said system is operable for managers to raise issues, alert managers of scheduling changes, arrange team meetings, and initiate phase exit reviews.

18. The system of claim 11, wherein said activities include phases, tasks, deliverables, and gates.

19. A system of managing programs for the development of products and services, comprising:
a database operative to store interdependencies between activities from a plurality of programs; and
a user interface operative for graphically displaying said interdependencies of said activities over a network in an electronic schedule, viewable and modifiable by program managers such that modification of a scheduled activity reestablishes said interdependencies in an updated, graphical display of said electronic schedule.

20. The system of claim 19, wherein said network is The Internet.

21. The system of claim 19, wherein said user interface is a JAVA application.

22. A computer-readable medium, the computer-readable medium having stored thereon a series of computer-executable instructions which, when executed by a processing component of a computer system, causes the processing component to manage programs with cross-program dependencies by:
graphically displaying said interdependencies of said activities in an electronic schedule, viewable by multiple program managers, such that modification of a scheduled activity reestablishes said interdependencies in an updated, graphical display of said electronic schedule.

23. A set of application program interfaces embodied on a computer-readable medium for execution on a computer in conjunction with an application program that manages programs, comprising:
a First Interface that receives First Interdependency Data from a First Program;
a Second Interface that receives and Second Interdependency Data from a Second Program;
a Third Interface that displays, said First Interdependency Data and said Second Interdependency Data in a program schedule wherein a modification of an activity in one of said programs causes an effect of said modification to said program schedule to be displayed.
